(19) United States
(12) Patent Application Publication
(10) Pub. No.: US 2024/0124666 A1
(43) Pub. Date: Apr. 18, 2024

(54) Polyimide, Method of Preparing Polyimide and Method of Selecting Polyimide Monomer

(71) Applicant: SK Innovation Co., Ltd., Seoul (KR)

(72) Inventors: Chang Q LEE, Daejeon (KR); Hyo Shin KWAK, Daejeon (KR); Cheol Min YUN, Daejeon (KR); Seung Min JEON, Daejeon (KR); Hyun Kyu CHO, Daejeon (KR)

(21) Appl. No.: 18/469,774

(22) Filed: Sep. 19, 2023

(30) Foreign Application Priority Data
Sep. 28, 2022 (KR) 10-2022-0123668

(51) Int. Cl. C08J 5/18; C08G 73/10

(52) U.S. Cl. CPC C08J 5/18; C08G 73/1007; C08J 2379/08

(57) ABSTRACT

A polyimide precursor monomer having an E value of 2.0 or more calculated by Equation 1 is selected among polyimide raw materials. A polyimide includes a structural unit derived from the polyimide precursor monomer having the E value of 2.0 or more. Optical properties of a polyimide film formed from the polyimide can be improved, and the optical properties of a polyimide film can be predicted from the E value of the polyimide precursor monomer even before production of the polyimide film.

### CROSS-REFERENCE TO RELATED APPLICATION AND CLAIM OF PRIORITY

This application claims priority to Korean Patent Applications No. 10-2022-0123668 filed on Sep. 28, 2022 in the Korean Intellectual Property Office (KIPO), the entire disclosure of which is incorporated by reference herein.

### BACKGROUND

### 1. Field

The present disclosure relates to a polyimide, a method of preparing a polyimide and a method of selecting a polyimide precursor monomer that may be used to prepare a polyimide.

### 2. Description of the Related Art

A polyimide has high heat resistance, flame retardancy, mechanical reliability, and low permittivity, and thus can be applied to an electronic material, a coating material, a molding material, a composite material, etc. For example, polyimide films are commonly applied as an integration material to semiconductor materials such as a liquid crystal display (LCD) and a plasma display panel (PDP).

Recently, flexible properties have been added to various electronic devices or electrochemical devices including a display device, and flexible electrical devices such as a flexible display have been developed. To provide mechanical reliability and heat resistance while providing sufficient flexibility required for the flexible electric device, a polyimide substrate is used as a flexible substrate material.

In an application requiring high optical properties such as a display, a colorless and transparent substrate may be needed to provide a high-quality image and a wide viewing angle. However, the polyimide may have low transmittance due to a charge transfer complex phenomenon occurring within a polymer structure. For example, a light in a visible ray region may be absorbed by π electrons present in a molecular structure, and the polyimide may be colored as brown or yellow.

To be applied to an electric device such as a flexible display, developments of a polyimide having high optical properties such as high transmittance, low refractive index, phase retardation, etc., while providing heat resistance, mechanical properties and flexibility may be required.

### SUMMARY

According to an aspect of the present disclosure, there is provided a polyimide having improved optical properties According to an aspect of the present disclosure, there is provided a polyimide film prepared using the polyimide.

According to an aspect of the present disclosure, there is provided a method of selecting a polyimide precursor monomer.

According to an aspect of the present disclosure, there is provided a method of preparing a polyimide using the polyimide precursor monomer.

A polyimide comprises a structural unit derived from a polyimide precursor monomer that has an E value of 2.0 or more calculated by Equation 1.

$$E = \frac{1 - 2.2 x}{y} \times \frac{1000}{Mw} \qquad [ Equation 1 ]$$

In Equation 1, x is an x value of the polyimide precursor monomer on a CIE xy chromaticity diagram, y is a y value of the polyimide precursor monomer on the CIE xy chromaticity diagram, and Mw is a molecular weight of the polyimide precursor monomer.

In some embodiments, the x value and the y value of the polyimide precursor monomer may be coordinate values calculated by Equations 2 and 3, respectively.

x=X_{Z}/(X_{Z}+Y_{Z}+1) [Equation 2]

y=Y_{Z}/(X_{Z}+Y_{Z}+1) [Equation 3]

In Equations 2 and 3, X_{Z} and Y_{Z} may be values calculated by Equations 4 and 5, respectively.

$${X}_{Z} = {\sum }_{λ = 380}^{780} X ( λ ) \cdot C ( λ ) \cdot {10}^{- A b s ( λ )} / {\sum }_{λ = 380}^{780} Z ( λ ) \cdot C ( λ ) \cdot {10}^{- A b s ( λ )} \qquad [ Equation 4 ]$$

$${Y}_{{Z}^{=}} {\sum }_{λ = 380}^{780} Y ( λ ) \cdot C ( λ ) \cdot {10}^{- A b s ( λ )} / {\sum }_{λ = 380}^{780} Z ( λ ) \cdot C ( λ ) \cdot {10}^{- A b s ( λ )} \qquad [ Equation 5 ]$$

In Equations 4 and 5, X(λ), Y(λ), and Z(λ) are values from color matching functions of a CIE standard observer at a corresponding wavelength λ on an CIE XYZ color space, C(λ) is a CIE standard light source C at the corresponding wavelength λ, and Abs(λ) is an absorbance of the polyimide precursor monomer at the corresponding wavelength λ.

In some embodiments, the absorbance of the polyimide precursor monomer may be a value obtained from a UV/Vis spectrum of the polyimide precursor monomer.

In some embodiments, the absorbance of the polyimide precursor monomer may be a value obtained from a UV/Vis spectrum of a molecular structure of the polyimide precursor monomer optimized by a density functional theory (DFT).

In some embodiments, the UV/Vis spectrum of the molecular structure of the polyimide precursor monomer may be calculated by a time-dependent density functional theory (TD-DFT).

In some embodiments, the E value of the polyimide precursor monomer may be in a range from 2.0 to 5.0.

In some embodiments, the polyimide precursor monomer may comprise a diamine monomer or a dianhydride monomer.

In some embodiments, the structural unit of the polyimide may include a structural unit derived from the diamine monomer having an E value of 2.0 or more, and a structural unit derived from the dianhydride monomer having an E value of 2.0 or more.

In some embodiments, the structural unit of the polyimide may include a structural unit derived from the diamine monomer having an E value of 2.0 to 3.0, and a structural unit derived from the dianhydride monomer having an E value of 2.0 or more. In some embodiments, the structural unit of the polyimide may include a structural unit derived from the diamine monomer having an E value of 2.0 or more, and the structural unit derived from the dianhydride monomer having an E value of 2.5 to 5.0.

In some embodiments, a content of the structural unit derived from the polyimide precursor monomer is 10 mol % or more.

A polyimide film prepared from the polyimide according to the above-described embodiments is provided.

In some embodiments, a yellowness index measured according to a standard of ASTM E313 of the polyimide film may be 3.5 or less.

In a method for selecting a polyimide precursor monomer, E values of each of polyimide raw materials are calculated according to Equation 1. A compound having an E value of 2.0 or more is selected among the polyimide raw materials.

$$E = \frac{1 - 2.2 x}{y} \times \frac{1000}{Mw} \qquad [ Equation 1 ]$$

In Equation 1, x is an x value of each of the polyimide raw materials on a CIE xy chromaticity diagram, y is a y value of the each of the polyimide raw materials on the CIE xy chromaticity diagram, and Mw is a molecular weight of the each of the polyimide raw materials.

In some embodiments, the x value and the y value of each of the polyimide raw materials may be calculated by Equations 2 and 3, respectively, before calculating the E values of each of the polyimide raw materials.

x=X_{Z}/(X_{Z}+Y_{Z}+1) [Equation 2]

y=Y_{Z}/(X_{Z}+Y_{Z}+1) [Equation 3]

In Equations 2 and 3, X_{Z} and Y_{Z} may be values calculated by Equations 4 and 5, respectively.

$${X}_{Z} = {\sum }_{λ = 380}^{780} X ( λ ) \cdot C ( λ ) \cdot {10}^{- A b s ( λ )} / {\sum }_{λ = 380}^{780} Z ( λ ) \cdot C ( λ ) \cdot {10}^{- A b s ( λ )} \qquad [ Equation 4 ]$$

$${Y}_{{Z}^{=}} {\sum }_{λ = 380}^{780} Y ( λ ) \cdot C ( λ ) \cdot {10}^{- A b s ( λ )} / {\sum }_{λ = 380}^{780} Z ( λ ) \cdot C ( λ ) \cdot {10}^{- A b s ( λ )} \qquad [ Equation 5 ]$$

In Equations 4 and 5, X(λ), Y(λ), and Z(λ) are values from color matching functions of a CIE standard observer at a corresponding wavelength λ on an CIE XYZ color space, C(λ) is a CIE standard light source C at the corresponding wavelength λ, and Abs(λ) is an absorbance of the polyimide raw material at the corresponding wavelength λ.

In some embodiments, the absorbance of each of the polyimide raw materials is obtained from a UV/Vis spectrum of each of the polyimide raw materials.

In some embodiments, before calculating the x value and y value of the polyimide raw material, the UV/Vis spectrum of each of the polyimide raw materials may be calculated by a time-dependent density functional theory (TD-DFT), and the absorbance of each of the polyimide raw materials may be calculated from the UV/Vis spectrum. In some embodiments, a structure of each of the polyimide raw materials may be optimized by a density functional theory (DFT) before calculating the UV/Vis spectrum of each of the polyimide raw materials.

In some embodiments, the polyimide raw materials may include a diamine monomer or a dianhydride monomer.

In a method of preparing a polyimide, a diamine monomer and a dianhydride monomer are reacted. At least one of the diamine monomer and the dianhydride monomer comprises a polyimide precursor monomer selected by the method according to the above-described embodiments.

In some embodiments, an E value of the diamine monomer and an E value of the dianhydride monomer are 2.0 or more.

In a preparation of a polyimide according to example embodiments, a polyimide precursor monomer having a predetermined parameter calculated by a specific formula may be used. The parameter of the polyimide precursor monomer may be calculated, so that the optical properties of a polyimide film may be predicted even before producing a polyimide. Polyimide raw materials selected under specific conditions may be selectively used in the production of the polyimide, so that unnecessary processes and waste of raw materials may be prevented.

A UV/Vis spectrum of the polyimide raw material may be calculated from a molecular structure of the polyimide raw material by a density functional theory and a time-dependent density functional theory. The above-mentioned parameter may be quantified from the UV/Vis spectrum and a CIE XYZ color correspondence function. Therefore, the above parameter can be calculated theoretically from the molecular structure of the polyimide raw material, so that process reliability may be improved and a process cost may be reduced.

The polyimide may include a structural unit derived from the above-described polyimide precursor monomer. Thus, the polyimide film may have improved optical properties while having high mechanical reliability and flexibility.

### BRIEF DESCRIPTION OF THE DRAWINGS

FIG. 1 is a CIE xy chromaticity diagram showing colors of polyimide precursor monomers according to Examples and Comparative Examples.

FIG. 2 is a graph plotting a yellowness index (Y.I) of a polyimide precursor monomer against an E value of the polyimide precursor monomer.

FIG. 3 is a graph plotting a yellowness index (Y.I) of a polyimide film against an E value of a polyimide precursor monomer from which it is prepared.

FIG. 4 is a graph showing a color correspondence function for a CIE 1931 2° standard observer.

FIG. 5 is a graph illustrating a CIE standard light source C.

FIGS. 6 and 7 are graphs showing UV/Vis spectra of diamine monomers according to Example 1 and Comparative Example 1, respectively.

### DETAILED DESCRIPTION OF THE EMBODIMENTS

According to embodiments provided in the present disclosure, a polyimide precursor monomer having predetermined optical properties is provided. A polyimide includes structural units derived from the above-mentioned polyimide precursor monomer. According to embodiments of the present disclosure, a method for selecting the polyimide precursor monomer and a method for preparing the polyimide are provided.

Hereinafter, embodiments of the present disclosure will be described in detail with reference to examples and the accompanying drawings. However, those skilled in the art will appreciate that such embodiments and drawings are provided to further understand the spirit of the present invention and do not limit subject matters to be protected as disclosed in the detailed description and appended claims.

<Polyimide Precursor Monomer>

The term “polyimide precursor monomer” used herein encompasses compounds capable of forming a polyimide e.g., through chemical reaction. For example, the polyimide precursor monomer may be a reactant used for preparing the polyimide. The polyimide precursor monomer may form an imide structure by a polymerization (e.g., via a condensation reaction) with a heterogeneous monomer.

In an embodiment, the polyimide precursor monomer may include a diamine monomer, a dianhydride monomer, or a mixture of diamine monomer and dianhydride monomers. For example, the diamine monomer and the dianhydride monomer may be polymerized with each other to form the polyimide.

In example embodiments, an E value of the polyimide precursor monomer may be calculated by Equation 1 below.

$$E = \frac{1 - 2.2 x}{y} \times \frac{1000}{Mw} \qquad [ Equation 1 ]$$

In Equation 1, x may be an x value of the polyimide precursor monomer on a CIE xy chromaticity diagram. y may be a y value of the polyimide precursor monomer on the CIE xy chromaticity diagram. the x value is a value on a x axis on the CIE xy chromaticity diagram, and the y value is a value on a y axis on the CIE xy chromaticity diagram.

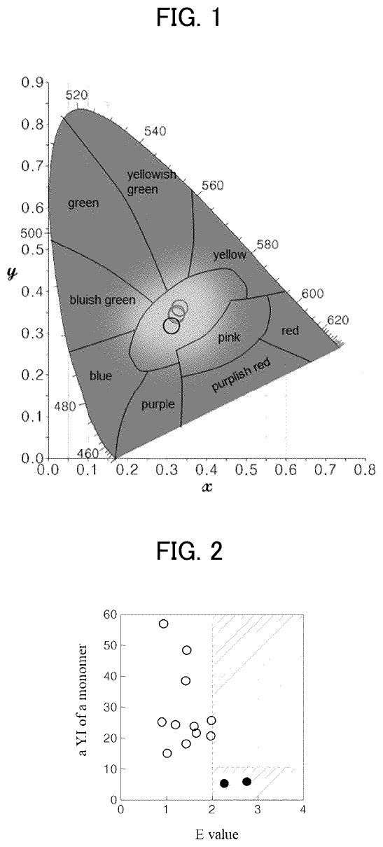

FIG. 1 is a CIE xy chromaticity diagram showing colors of polyimide precursor monomers according to Examples and Comparative Examples. For example, x and y may represent an x coordinate value and a y coordinate value corresponding to a color of the polyimide precursor monomer when the color of the polyimide precursor monomer is expressed on the CIE xy chromaticity diagram.

In Equation 1, Mw is a molecular weight of the polyimide precursor monomer.

In example embodiments, the E value of the polyimide precursor monomer may be 2.0 or more.

In an embodiment, the polyimide may be prepared by selectively using the polyimide precursor monomer. For example, an E value of each of polyimide raw materials is calculated according to Equation 1, and a polyimide raw material having an E value of 2.0 or more may be selected among the polyimide raw materials as the polyimide precursor monomer used in the polyimide preparation.

The term “a polyimide raw material” or “a compound” as used herein may refer to a homogeneous monomer group, and the “polyimide raw materials” or “compounds” may encompass at least two monomer groups.

The term “homogeneous” as used herein may refer to the same molecular structure or the same E value. The term “same” as used herein includes the cases having the same value quantitatively or arithmetically, and having a predetermined error within a range capable of being recognized as substantially the same value.

If the polyimide precursor monomer has the E value of 2.0 or more, optical properties of a polyimide film prepared therefrom may be improved. For example, the polyimide precursor monomer having the E value of 2.0 or more may be used, absorption of a visible light due to a charge transfer complex (CTC) in the polyimide structure may be suppressed. Thus, the polyimide film may have a low yellow index and a high transmittance.

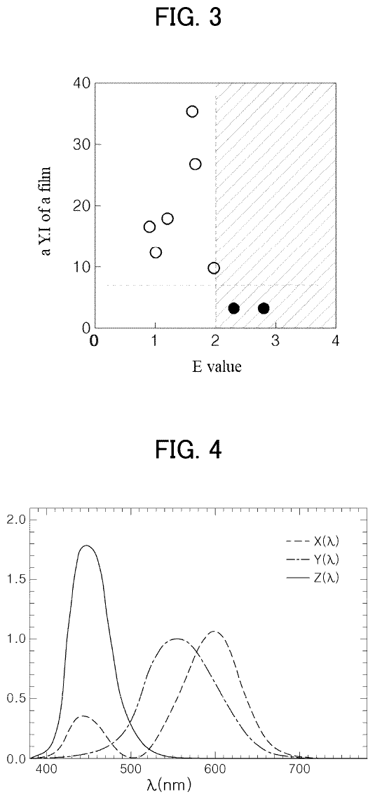

FIG. 2 is a graph showing a yellowness index (Y.I) of a polyimide precursor monomer according to an E value of the polyimide precursor monomer. FIG. 3 is a graph showing a yellowness index (Y.I) of a polyimide film according to an E value of a polyimide precursor monomer.

Referring to FIGS. 2 and 3, the E value of the polyimide precursor monomer calculated by Equation 1 may have a predetermined correlation with the yellow index of the polyimide precursor monomer and the yellow index of the polyimide film.

For example, when the E value of the polyimide precursor monomer is 2.0 or more, the yellow index of the polyimide precursor monomer and the polyimide film may be enhanced. Thus, the polyimide film may have high transparency and optical properties.

In an embodiment, the E value of the polyimide precursor monomer may be in a range from 2.0 to 5.0. Within the above range, the optical properties of the polyimide film prepared from the polyimide precursor monomer may be further improved.

In example embodiments, the inherent E value of the polyimide precursor monomer may be calculated, the optical properties of the polyimide film may be predicted even before producing the polyimide. Accordingly, raw materials suitable for producing the polyimide may be selected/used in advance, so that unnecessary processes and waste of raw materials may be prevented, and time and cost for the polyimide production may be reduced.

In some embodiments, the x-coordinate value and the y-coordinate value of the polyimide precursor monomer or the raw material may be calculated by Equations 2 and 3, respectively.

x=X_{Z}/(X_{Z}+Y_{Z}+1) [Equation 2]

y=Y_{Z}/(X_{Z}+Y_{Z}+1) [Equation 3]

In Equations 2 and 3, Xz and Yz may be values calculated by Equations 4 and 5, respectively.

X_{Z}=Σ_{λ=380}⁷⁸⁰X(λ)·C(λ)·10^{-Abs(λ)}/Σ_{λ=380}⁷⁸⁰Z(λ)·C(λ)·10^{-Abs(λ)} [Equation 4]

Y_{Z}=Σ_{λ=380}⁷⁸⁰Y(λ)·C(λ)·10^{-Abs(λ)}/Σ_{λ=380}⁷⁸⁰Z(λ)·C(λ)·10^{-Abs(λ)} [Equation 5]

In Equations 4 and 5, X(λ), Y(λ), and Z(λ) may be values from color matching functions of the CIE standard observer at corresponding wavelength λ on an CIE XYZ color space.

For example, the color matching function is a function that numerically describes a color response of the observer, and the X(λ), Y(λ), and Z(λ) represent color matching functions to a CIE 1931 2° standard observer.

FIG. 4 is a graph showing a color matching function for a CIE 1931 2° standard observer. Referring to FIG. 4, X(λ), Y(λ), and Z(λ) in Equations 4 and 5 are each a value from a vertical axis at corresponding λ of the corresponding function.

In Equations 4 and 5 above, C(λ) is a CIE standard light source C at the corresponding k.

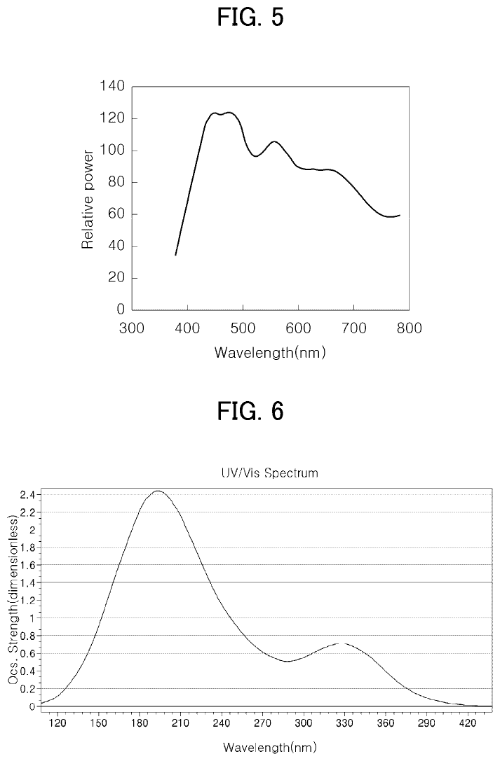

FIG. 5 is a graph illustrating a CIE standard light source C. Referring to FIG. 5, C(λ) is a value from a vertical axis at the corresponding λ.

In Equations 4 and 5, Abs(λ) is an absorbance of the polyimide precursor monomer at the corresponding λ. In an embodiment, the absorbance of the polyimide precursor monomer may be obtained from a UV/Vis spectrum of the polyimide precursor monomer.

In some embodiments, the UV/Vis spectrum of the polyimide precursor monomer may be theoretically calculated from a molecular structure of the polyimide precursor monomer. For example, the UV/Vis spectrum of the polyimide precursor monomer may be calculated or predicted by a density functional theory (DFT) and a time-dependent density functional theory (TD-DFT).

In an embodiment, the structure of the polyimide precursor monomer may be optimized by the density functional theory (DFT). For example, a molecular structure of the polyimide precursor monomer in a three-dimensional space can be optimized by applying the density functional theory.

For example, the molecular structure can be optimized using Dmol³ module of Materials Studio software (Biovia). GGA-PBE (general gradient approximation applying Perdew-Burke-Ernzerhof) may be used as a functional, COSMO model of DMAc solvent environment and DNP condition may be used as a basis set.

In an embodiment, the UV/Vis spectrum of the polyimide precursor monomer having the optimized structure may be calculated by the time-dependent density functional theory (TD-DFT). For example, the UV/Vis spectrum may be approximated through an adiabatic local-density approximation (ALDA) method under the same calculation conditions as those of the structure optimization process.

For example, an electron transition wavelength of the polyimide precursor monomer may be calculated through the adiabatic local density approximation method, and the electron transition wavelength may be approximately fitted by a Gaussian function. In an embodiment, the approximation using the Gaussian function may use 50 nm of a full width at half maximum (FWHM) or a smearing width.

In some embodiments, the UV/Vis spectrum of the polyimide precursor monomer may be measured using a UV/Vis spectrophotometer. For example, a UV/Vis spectrum of the polyimide precursor monomer-mixed solvent may be measured using the UV/Vis spectrophotometer.

In an embodiment, the absorbance of the polyimide precursor monomer may be a value obtained from the UV/Vis spectrum of the polyimide precursor monomer. For example, the absorbance of the polyimide precursor monomer at each wavelength may be generated, measured, or calculated using the UV/Vis spectrum obtained by the above-described method. The term “obtained” as used herein may refer to being measured, analyzed, generated, estimated, or calculated using any material, device, drawing, graph, function, mathematical formula or input value.

In an embodiment, the absorbance of the polyimide precursor monomer may be quantified by the density functional theory and the time-dependent density functional theory, so that the E value may be theoretically calculated from the molecular structure of the polyimide precursor monomer. Thus, the optical properties of the polyimide film may be predicted only using the molecular structure of the polyimide precursor monomer. Therefore, the polyimide production process may be easily performed and the process cost may be reduced.

Additionally, actual measurement and experimentation of the polyimide film may not be required, so that variables such as measurement conditions and experimental environments may be minimized. Accordingly, errors and deviations according to the measurement conditions and environments may be reduced. Thus, process reliability and efficiency may be enhanced, and the polyimide film having high quality and reliability may be produced.

In some embodiments, the yellow index (Y.I) of the polyimide precursor monomer may be 7.0 or less, and may be 6.0 or less in an embodiment. For example, the yellow index may be a value measured according to ASTM E313 standard for a solution in which an organic solvent (e.g., DMAc) and the polyimide precursor monomer are uniformly mixed.

The polyimide precursor monomer selected by the above method may have the E value of 2.0 or more, and thus may have the low yellow index. Thus, the transparency of the polyimide precursor monomer may be enhanced, and the optical properties of the polyimide may be improved.

The method for selecting the polyimide precursor monomer according to example embodiments is based on Ab initio based methodology, and the color of polyimide may be theoretically calculated from the structure of the monomer. Accordingly, accuracy, reliability and productivity may be improved compared to those from a machine learning-based methodology that derives a polyimide color correlation based on actual experimental results.

<Polyimide and Polyimide Film>

In example embodiments, the polyimide may include a structural unit derived from the polyimide precursor monomer as described above. For example, the polyimide may include a structural unit derived from the polyimide precursor monomer having the E value of 2.0 or more.

The polyimide includes the above-mentioned structural unit, so that the charge transfer complex (CTC) phenomenon in the molecular structure may be suppressed, and an absorbance of visible light may be lowered. Accordingly, the polyimide may have a low yellow index, and a reduction of a visible light transmittance may be prevented.

Further, the E value may be calculated from the structure of the polyimide precursor monomer and the optical properties of the polyimide may be predicted in advance, so that a suitable polyimide precursor monomer may be selectively used according to the purpose of use and the application target. Therefore, the reliability of the polyimide film may be improved, and defects and discoloration of the polyimide film may be prevented.

The polyimide may be prepared by reacting a diamine monomer and a dianhydride monomer. For example, the polyimide may be formed by a condensation polymerization of the diamine monomer and the dianhydride monomer.

In some embodiments, the diamine monomer and the dianhydride monomer may be polymerized to form a polyimide precursor in the form of a polyamic acid polymer. The polyimide precursor may be converted into the polyimide through an imidization reaction.

In the preparation of the polyimide, a molar ratio of the diamine monomer (or a unit derived therefrom) and the dianhydride monomer (or a unit derived therefrom) may be included in substantially the same equivalent amount.

For example, the molar ratio of the dianhydride monomer to the diamine monomer may be from 0.9 to 1.1, from 0.95 to 1.05, or from 0.98 to 1.02. At least one of the diamine monomer and the dianhydride monomer may comprise the polyimide precursor monomer having the E value of 2.0 or more.

In example embodiments, a content of the structural unit derived from the polyimide precursor monomer having the E value of 2.0 or more among total structural units of the polyimide may be 10 mol % or more, e.g., 20 mol % or more, or 30 mol % or more.

In an embodiment, the content of the structural unit derived from the polyimide precursor monomer may be in a range from 10 mol % to 100 mol %, from 20 mol % to 90 mol %, or from 30 mol % to 90 mol %. Within the above range, the optical properties of the polyimide may be improved while having high flexibility, bending properties and mechanical strength.

In some embodiments, both the diamine monomer and the dianhydride monomer may have the E value of 2.0 or more. For example, the polyimide may include a structural unit derived from the diamine monomer having the E value of 2.0 or more, and a structural unit derived from the dianhydride monomer having the E value of 2.0 or more. Accordingly, the optical properties of the polyimide may be further improved, and the polyimide film having a low refractive index, an improved retardation and a wide viewing angle may be provided.

In an embodiment, the polyimide may include a structural unit derived from the diamine monomer having the E value from 2.0 to 3.0, and a structural unit derived from the dianhydride monomer having the E value of 2.0 or more.

In an embodiment, the polyimide may include a structural unit derived from the diamine monomer having the E value of 2.0 or more, and a structural unit derived from the dianhydride monomer having the E value from 2.5 to 5.0.

The polyimide may include the diamine monomer-derived unit and the dianhydride monomer-derived unit each having the E value within the above range, so that visible light transmittance may be further improved, and yellowing and discoloration of the film may be further suppressed.

For example, the polyimide may include a structural unit derived from the diamine monomer having the E value from 2.0 to 3.0 and a structural unit derived from the dianhydride monomer having the E value from 2.5 to 5.0. Accordingly, the optical properties of the polyimide film may be further improved.

In an embodiment, a content of diamine-derived structural units having the E value of 2.0 or more among the diamine-derived structural units may be 10 mol % or more. For example, the content of the diamine-derived structural unit having the E value of 2.0 or more among the diamine-derived structural units may be 20 mol % or more, and may be, e.g., from 20 mol % to 90 mol %.

In an embodiment, a content of dianhydride-derived structural units having the E value of 2.0 or more among the dianhydride-derived structural units may be 10 mol % or more. For example, the content of a dianhydride-derived structural unit having the E value of 2.0 or more among the dianhydride-derived structural units may be 20 mol % or more, and may be, e.g., from 20 mol % to 90 mol %.

In some embodiments, the polyimide may further include a structural unit derived from a sub-monomer in addition to the structural units derived from the polyimide precursor monomers as described above.

In an embodiment, the sub-monomer may include an aromatic diamine monomer or an aromatic dianhydride monomer. The term “aromatic” used herein may refer to a compound having aromaticity entirely or a compound in which an aromatic ring such as a benzene ring is partially included in a molecular structure.

The polyimide may include a unit derived from the aromatic diamine monomer or the aromatic dianhydride monomer to have more stable mechanical properties, high heat resistance and a high glass transition temperature.

The polyimide film may include the polyimide. For example, the polyimide film may be formed using a polyimide composition containing the polyimide.

For example, the polyimide composition may be coated on a glass substrate and cured to prepare the polyimide film. In an embodiment, the curing process may include drying and thermal curing.

In an embodiment, the polyimide composition may further include an organic solvent dissolving the polyimide.

In an embodiment, the polyimide composition may be prepared by adding and mixing the polyimide prepared by a polymerization of the polyimide precursor monomers in the organic solvent.

In an embodiment, the polyimide composition may be prepared by a solution polymerization of the polyimide precursor monomers in a mixed state in an organic solvent.

The organic solvent may include ethylene glycol monomethyl ether, ethylene glycol monoethyl ether, methyl cellosolve acetate, ethyl cellosolve acetate, diethylene glycol monomethyl ether, diethylene glycol monoethyl ether, propylene glycol methyl ether, propylene glycol methyl ether acetate, propylene glycol propyl ether acetate, 1-methoxy-2-propanol acetate, 1-methoxy-2-propanol, diethylene glycol dimethyl ether, ethyl lactate, toluene, xylene, methyl ethyl ketone, cyclohexanone, heptanone, γ-butyrolactone, N-methyl-2-pyrrolidone (NMP), m-cresol, N,N-diethylacetamide, etc. These may be used alone or in a combination thereof.

In an embodiment, the polyimide composition may include a polyimide precursor in the form of a polyamic acid polymer. In this case, the production of the polyimide film and the imidization reaction of the polyimide precursor may be performed together.

In some embodiments, a yellow index (Y.I) of the polyimide film may be 4.0 or less, and may be 3.5 or less in one embodiment. For example, the yellow index may be a value measured according to ASTM E313 standard for a polyimide film having a thickness of 50±1 μm.

The polyimide precursor monomer selected by the selection method according to the above-described embodiments may be used, so that the polyimide film may have a low yellow index. Accordingly, the polyimide film may have colorless and transparent properties, and may be applied as a flexible substrate, a window material, etc., in an optical field such as a display. Thus, improved visibility, high-quality image and a wide viewing angle may be implemented while achieving mechanical properties and flexibility of a display substrate.

Hereinafter, exemplary examples are proposed to more concretely describe the present inventive concepts. However, the following examples are only given for illustrating the present inventive concepts and those skilled in the related art will obviously understand that various alterations and modifications are possible within the scope and spirit of the present invention. Such alterations and modifications are duly included in the appended claims.

### Example 1

Calculation of E Value of Diamine A

A structure optimization was performed using a density functional theory (DFT) for diamine A represented by Chemical Formula 1 below, and a UV/Vis spectrum of the structure-optimized diamine A was obtained using a time-dependent density functional theory (TD-DFT).

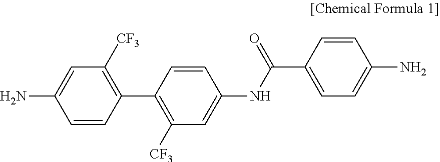 [SMILES: Nc1ccc(C(=O)Nc2ccc(-c3ccc(N)cc3C(F)(F)F)c(C(F)(F)F)c2)cc1]

Specifically, the molecular structure was optimized using Dmol³ module and GGA-PBE Functional of Materials Studio software (BIOVIA). As a basis set, COSMO model of DMAc solvent environment and DNP condition was used. Thereafter, an electron transition wavelength value was calculated by an adiabatic local density approximation (ALDA) method under the same calculation conditions, and then the electron transition wavelength value was approximated with a Gaussian function to obtain the UV/Vis spectrum of the optimized molecule. In the Gaussian function approximation, 50 nm of a smearing width was used.

FIG. 6 is a graph showing a UV/Vis spectrum of the diamine A measured as described above.

Referring to FIG. 6, a value on a horizontal axis is a wavelength (λ), and a value on a vertical axis is an absorbance (Abs(λ)) of the diamine A at the corresponding wavelength (λ).

The absorbance of the diamine A was obtained from the UV/Vis spectrum, and X_{Z} and Y_{Z} of the diamine A were calculated using the above-described Equation 4 and Equation 5. Thereafter, the x-coordinate value (0.311) and the y-coordinate value (0.318) of the diamine A were calculated using the above-described Equations 2 and 3.

The E value of the diamine A was calculated by substituting the color coordinate values into Equation 1. The obtained E value of the diamine A was 2.265.

Preparation of Polyimide Composition

N,N-dimethylacetamide (DMAc) and 2,2′-bis(trifluoromethyl)-benzidine (TFMB) were put in a reactor under a nitrogen atmosphere and sufficiently stirred, and then terephthaloyldichloride (TPC) was added to be dissolved and reacted while being stirred for 6 hours. The reaction product was precipitated and filtered using an excess amount of water, and then vacuum dried at 90° C. for 6 hours or more to obtain a polyamide oligomer.

DMAc, the polyamide oligomer, TFMB and the diamine A were added to a reactor under a nitrogen atmosphere.

Cyclobutanetetracarboxylic dianhydride (CB DA) and 4,4′-(hexafluoroisopropylidene)-diphthalic anhydride (6FDA) were sequentially introduced into the reactor. In the preparation, each monomer was added to a molar ratio of TFMB:diamine A:TPC:6FDA:CBDA=70:30:55:15:30. The mixed solution (solid content: 10 wt %) was dissolved and reacted while being stirred at 40° C. for 12 hours to prepare a polyimide precursor solution.

Pyridine and acetic anhydride were added to the polyimide precursor solution in each amount of 2.5 times a total mole of dianhydride and stirred at 60° C. for 12 hours to prepare a polyimide composition containing a polyimide polymer. A weight average molecular weight of the polyimide polymer was 280,000 g/mol.

Fabrication of Polyimide Film

The polyimide composition was solution-cast on a glass substrate using an applicator. Thereafter, the applied composition was dried at 90° C. for 30 minutes using a convection oven, heat-treated at 280° C. for 1 hour under a nitrogen air flow condition, and then cooled at room temperature to form a film on the glass substrate. The film was separated from the substrate to obtain a polyimide film having a thickness of about 49 μm.

### Example 2

A polyimide composition and a film were prepared by the same method as that in Example 1, except a diamine B represented by Chemical Formula 2 was used instead of the diamine A.

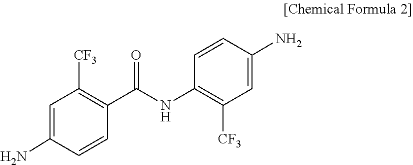 [SMILES: Nc1ccc(NC(=O)c2ccc(N)cc2C(F)(F)F)c(C(F)(F)F)c1]

An E value of the diamine B was calculated by the same method as that in Example 1. X-value and y-value of the color coordinates of the diamine B calculated by the above-described method were 0.311 and 0.317, respectively, and the E value was 2.747.

### Comparative Example 1

A polyimide composition and a film were prepared by the same method as that in Example 1, except a diamine C represented by Chemical Formula 3 was used instead of the diamine A.

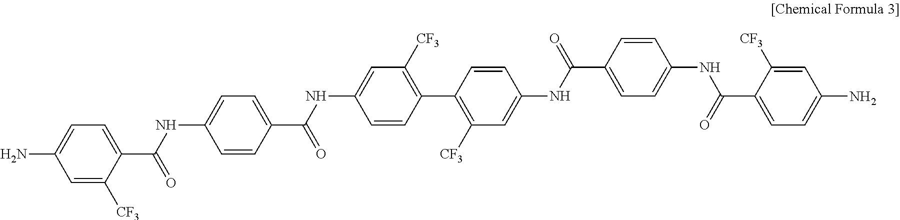 [SMILES: Nc1ccc(C(=O)Nc2ccc(C(=O)Nc3ccc(-c4ccc(NC(=O)c5ccc(NC(=O)c6ccc(N)cc6C(F)(F)F)cc5)cc4C(F)(F)F)c(C(F)(F)F)c3)cc2)c(C(F)(F)F)c1]

An E value of the diamine C was calculated by the same method as that in Example 1. X-value and y-value of the color coordinates of the diamine B calculated by the above-described method were 0.323 and 0.343, respectively, and the E value was 0.908.

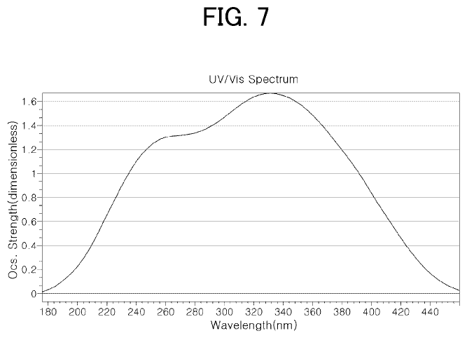

FIG. 7 is a graph showing a UV/Vis spectrum of the diamine C measured by the method as described above.

### Comparative Example 2

A polyimide composition and a film were prepared by the same method as that in Example 1, except a diamine D represented by Chemical Formula 4 was used instead of the diamine A.

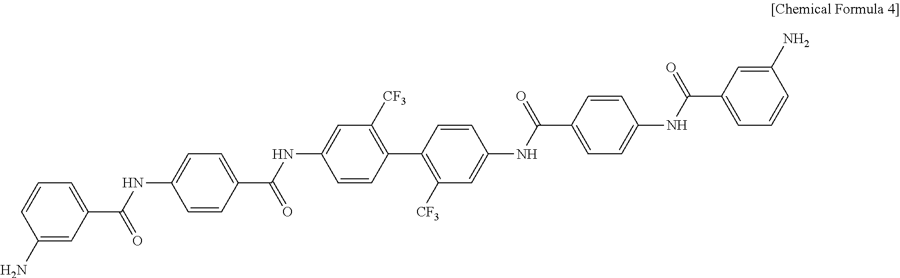 [SMILES: Nc1cccc(C(=O)Nc2ccc(C(=O)Nc3ccc(-c4ccc(NC(=O)c5ccc(NC(=O)c6cccc(N)c6)cc5)cc4C(F)(F)F)c(C(F)(F)F)c3)cc2)c1]

An E value of the diamine D was calculated by the same method as that in Example 1. X-value and y-value of the color coordinates of the diamine D calculated by the above method were 0.332 and 0.360, respectively, and the E value was 0.941.

### Comparative Example 3

A polyimide composition and film were prepared by the same method as that in Example 1, except that a diamine E represented by Chemical Formula 5 was used instead of the diamine A.

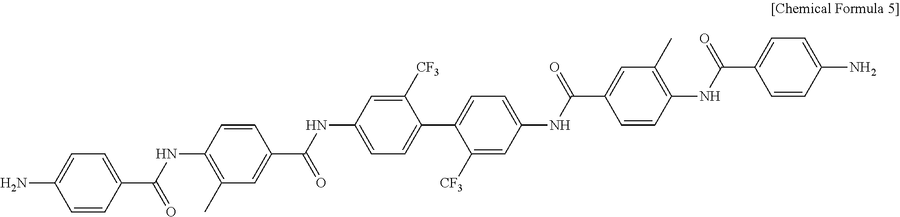 [SMILES: Cc1cc(C(=O)Nc2ccc(-c3ccc(NC(=O)c4ccc(NC(=O)c5ccc(N)cc5)c(C)c4)cc3C(F)(F)F)c(C(F)(F)F)c2)ccc1NC(=O)c1ccc(N)cc1]

An E value of the diamine E was calculated by the same method as that in Example 1. X-value and y-value of the color coordinates of the diamine E calculated by the above method were 0.323 and 0.345, respectively, and the E value was 1.015.

### Comparative Example 4

A polyimide composition and film were prepared by the same method as that in Example 1, except that a diamine F represented by Chemical Formula 6 was used instead of the diamine A.

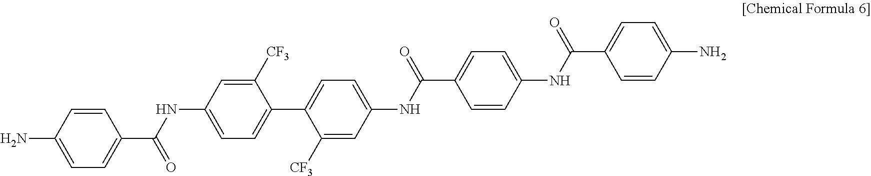 [SMILES: Nc1ccc(C(=O)Nc2ccc(C(=O)Nc3ccc(-c4ccc(NC(=O)c5ccc(N)cc5)cc4C(F)(F)F)c(C(F)(F)F)c3)cc2)cc1]

An E value of the diamine F was calculated by the same method as that in Example 1. X-value and y-value of the color coordinates of the diamine F calculated by the above method were 0.326 and 0.348, respectively, and the E value was 1.202.

### Comparative Example 5

A polyimide composition and a film were prepared by the same method as that in Example 1, except that a diamine G represented by Chemical Formula 7 was used instead of the diamine A.

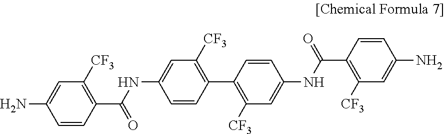 [SMILES: Nc1ccc(C(=O)Nc2ccc(-c3ccc(NC(=O)c4ccc(N)cc4C(F)(F)F)cc3C(F)(F)F)c(C(F)(F)F)c2)c(C(F)(F)F)c1]

An E value of the diamine G was calculated by the same method as that in Example 1. X-value and y-value of the color coordinates of the diamine G calculated by the above method were 0.311 and 0.319, respectively, and the E value was 1.426.

### Comparative Example 6

A polyimide composition and a film were prepared by the same method as that in Example 1, except that a diamine H represented by Chemical Formula 8 was used instead of the diamine A.

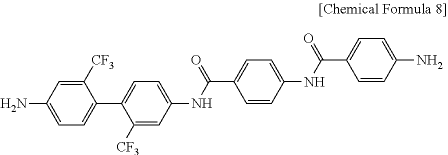 [SMILES: Nc1ccc(C(=O)Nc2ccc(C(=O)Nc3ccc(-c4ccc(N)cc4C(F)(F)F)c(C(F)(F)F)c3)cc2)cc1]

An E value of the diamine H was calculated by the same method as that in Example 1. X-value and y-value of the color coordinates of the diamine H calculated by the above method were 0.327 and 0.349, respectively, and the E value was 1.434. Comparative Example 7

A polyimide composition and a film were prepared by the same method as that in Example 1, except that a diamine I represented by Chemical Formula 9 was used instead of the diamine A.

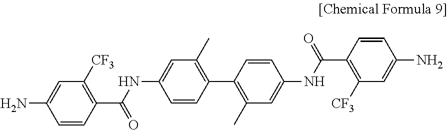 [SMILES: Cc1cc(NC(=O)c2ccc(N)cc2C(F)(F)F)ccc1-c1ccc(NC(=O)c2ccc(N)cc2C(F)(F)F)cc1C]

An E value of the diamine I was calculated by the same method as that in Example 1. X-value and y-value of the color coordinates of the diamine I calculated by the above method were 0.323 and 0.343, respectively, and the E value was 1.438.

### Comparative Example 8

A polyimide composition and a film were prepared by the same method as that in Example 1, except that a diamine J represented by Chemical Formula 10 was used instead of the diamine A.

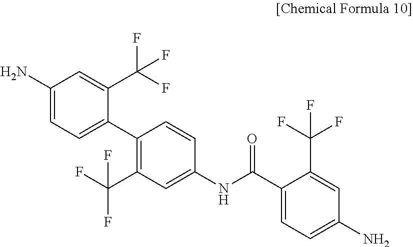 [SMILES: Nc1ccc(C(=O)Nc2ccc(-c3ccc(N)cc3C(F)(F)F)c(C(F)(F)F)c2)c(C(F)(F)F)c1]

An E value of the diamine J was calculated by the same method as that in Example 1. X-value and y-value of the color coordinates of the diamine J calculated by the above method were 0.311 and 0.318, respectively, and the E value was 1.962. Comparative Example 9

A polyimide composition and a film were prepared by the same method as that in Example 1, except that a diamine K represented by Chemical Formula 11 was used instead of the diamine A.

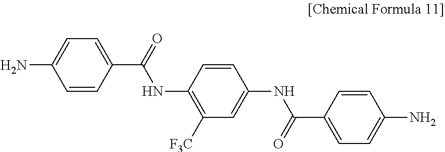 [SMILES: Nc1ccc(C(=O)Nc2ccc(NC(=O)c3ccc(N)cc3)c(C(F)(F)F)c2)cc1]

An E value of the diamine K was calculated by the same method as that in Example 1. X-value and y-value of the color coordinates of the diamine K calculated by the above method were 0.327 and 0.342, respectively, and the E value was 1.975.

### Comparative Example 10

A polyimide composition and a film were prepared by the same method as that in Example 1, except that a diamine L represented by Chemical Formula 12 was used instead of the diamine A.

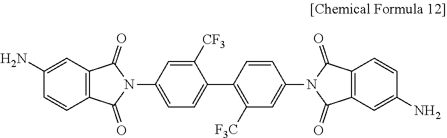 [SMILES: Nc1ccc2c(c1)C(=O)N(c1ccc(-c3ccc(N4C(=O)c5ccc(N)cc5C4=O)cc3C(F)(F)F)c(C(F)(F)F)c1)C2=O]

An E value of the diamine L was calculated by the same method as that in Example 1. X-value and y-value of the diamine L calculated by the above method were 0.312 and 0.320, respectively, and the E value was 1.601.

### Comparative Example 11

A polyimide composition and a film were prepared by the same method as that in Example 1, except that a diamine M represented by Chemical Formula 13 was used instead of the diamine A.

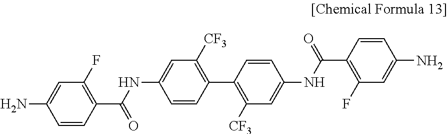 [SMILES: Nc1ccc(C(=O)Nc2ccc(-c3ccc(NC(=O)c4ccc(N)cc4F)cc3C(F)(F)F)c(C(F)(F)F)c2)c(F)c1]

An E value of the diamine M was calculated by the same method as that in Example 1. X-value and y-value of the diamine M calculated by the above method were 0.312 and 0.320, respectively, and the E value was 1.648.

### Experimental Example

(1) Measurement of Yellowness Index (Y.I) of Diamine

1.00 g of the diamine used in Examples and Comparative Examples and 9.00 g of DMAc were added to a 20 ml beaker and mixed uniformly. A yellowness index (Y.I) of the mixed solution was measured using a spectrophotometer (Nippon Denshoku, COH-5500) according to a standard of ASTM E313.

(2) Evaluation on Yellowness Index (Y.I) of Polyimide Film

A yellowness index (Y.I) of the polyimide film (thickness: 49 μm) of each of Examples and Comparative Examples was measured using a spectrophotometer (Nippon Denshoku, COH-5500) in accordance with a standard of ASTM E313.

The case that the yellowness of the film was excessively high and could not be substantially measured was indicated as “-”.

The results are shown in Table 1 below.

TABLE 1

| | diamine monomer | | | | |
|---|---|---|---|---|---|
| No. | x-value | y-value | E value | Y.I. | film Y.I. |
| Example 1 | 0.311 | 0.318 | 2.265 | 5.52 | 3.4 |
| Example 2 | 0.311 | 0.317 | 2.747 | 6.14 | 3.41 |
| Comparative | 0.323 | 0.343 | 0.908 | 25.06 | 16.81 |
| Example 1 | | | | | |
| Comparative | 0.332 | 0.360 | 0.941 | 56.66 | — |
| Example 2 | | | | | |
| Comparative | 0.323 | 0.345 | 1.015 | 15.0 | 12.44 |
| Example 3 | | | | | |
| Comparative | 0.326 | 0.348 | 1.202 | 24.3 | 18.1 |
| Example 4 | | | | | |
| Comparative | 0.311 | 0.319 | 1.426 | 38.22 | — |
| Example 5 | | | | | |
| Comparative | 0.327 | 0.349 | 1.434 | 18.1 | — |
| Example 6 | | | | | |
| Comparative | 0.323 | 0.343 | 1.438 | 48.09 | — |
| Example 7 | | | | | |
| Comparative | 0.311 | 0.318 | 1.962 | 20.69 | 9.9 |
| Example 8 | | | | | |
| Comparative | 0.327 | 0.342 | 1.975 | 25.43 | — |
| Example 9 | | | | | |
| Comparative | 0.312 | 0.320 | 1.601 | 23.6 | 35.5 |
| Example 10 | | | | | |
| Comparative | 0.312 | 0.320 | 1.648 | 21.45 | 27.0 |
| Example 11 | | | | | |

Referring to Table 1, in Examples using the above-described polyimide precursor monomer as the diamine, brown and yellow coloring were prevented while improved transmittance and low yellow index were obtained. Additionally, the yellowness index of the diamine was lowered compared to those from Comparative Examples.

In Comparative Examples, the E value of the diamine was less than 2.0, and the diamine monomer or the film had high yellowness indices.

FIG. 1 is a CIE xy chromaticity diagram showing x values and y values of diamine monomers according to Examples and Comparative Examples calculated by the above method. In FIG. 1, black circles represent coordinate values of the diamine monomers according to Examples and gray circles represent coordinate values of the diamine monomers according to Comparative Examples.

Referring to FIG. 1, the diamine monomers according to Examples and Comparative Examples are distributed in adjacent regions on the chromaticity diagram. However, the diamine monomers according to Comparative Examples had an E value of less than 2.0, and thus the yellowness index of the polyimide film was relatively high.

FIGS. 2 and 3 are graphs showing E values and yellowness indices measured from Examples and Comparative Examples.

FIG. 2 is a graph showing the yellowness index (Y.I) of the diamine according to the E value of the diamine. FIG. 3 is a graph showing the yellowness index (Y.I) of the polyimide film according to the E value of the diamine.

Referring to FIGS. 2 and 3, when the E value of the diamine was less than 2.0, the yellowness index of the diamine and the yellowness index of the polyimide film were randomly distributed. When the E value of the diamine was less than 2.0, no correlation between the E value of the diamine and the yellow index of the polyimide film was provided, and the yellowness indices of the diamine and the polyimide film became entirely high.

However, when the diamine had an E value of 2.0 or more, both the yellowness index of the diamine and the yellowness index of the polyimide film were lowered. Accordingly, a polyimide prepared using the polyimide precursor monomer having the E value of 2.0 or more may have low yellowness index and high transparency.

What is claimed is:

1. A polyimide comprising a structural unit derived from a polyimide precursor monomer, wherein the polyimide precursor monomer has an E value of 2.0 or more calculated by Equation 1:
$$E = \frac{1 - 2.2 x}{y} \times \frac{1000}{Mw} \qquad [ Equation 1 ]$$
wherein, in Equation 1, x is an x value of the polyimide precursor monomer on a CIE xy chromaticity diagram, y is a y value of the polyimide precursor monomer on the CIE xy chromaticity diagram, and Mw is a molecular weight of the polyimide precursor monomer.

2. The polyimide according to claim 1, wherein the x value and the y value of the polyimide precursor monomer are coordinate values calculated by Equations 2 and 3, respectively:
x=X_{Z}/(X_{Z}+Y_{Z}+1) [Equation 2]
y=Y_{Z}/(X_{Z}+Y_{Z}+1) [Equation 3]
wherein, in Equations 2 and 3, X_{Z} and Y_{Z} are values calculated by Equations 4 and 5, respectively:
$${X}_{Z} = {\sum }_{λ = 380}^{780} X ( λ ) \cdot C ( λ ) \cdot {10}^{- A b s ( λ )} / {\sum }_{λ = 380}^{780} Z ( λ ) \cdot C ( λ ) \cdot {10}^{- A b s ( λ )} \qquad [ Equation 4 ]$$
$${Y}_{{Z}^{=}} {\sum }_{λ = 380}^{780} Y ( λ ) \cdot C ( λ ) \cdot {10}^{- A b s ( λ )} / {\sum }_{λ = 380}^{780} Z ( λ ) \cdot C ( λ ) \cdot {10}^{- A b s ( λ )} \qquad [ Equation 5 ]$$
wherein, in Equations 4 and 5, X(λ), Y(λ), and ZOO are values from color matching functions of a CIE standard observer at a corresponding wavelength λ on an CIE XYZ color space, C(λ) is a CIE standard light source C at the corresponding wavelength λ, and Abs(λ) is an absorbance of the polyimide precursor monomer at the corresponding wavelength λ.

3. The polyimide according to claim 2, wherein the absorbance of the polyimide precursor monomer is a value obtained from a UV/Vis spectrum obtained from a molecular structure of polyimide precursor monomer, wherein the molecular structure of polyimide precursor monomer is optimized by a density functional theory (DFT).

4. The polyimide according to claim 3, wherein the UV/Vis spectrum is calculated from the molecular structure of the polyimide precursor monomer by a time-dependent density functional theory (TD-DFT).

5. The polyimide according to claim 1, wherein the E value of the polyimide precursor monomer is in a range from 2.0 to 5.0.

6. The polyimide according to claim 1, wherein the polyimide precursor monomer comprises a diamine monomer or a dianhydride monomer.

7. The polyimide according to claim 6, wherein the structural unit of the polyimide comprises a structural unit derived from the diamine monomer having an E value of 2.0 or more, and a structural unit derived from the dianhydride monomer having an E value of 2.0 or more.

8. The polyimide according to claim 6, wherein the structural unit of the polyimide comprises a structural unit derived from the diamine monomer having an E value of 2.0 to 3.0, and a structural unit derived from the dianhydride monomer having an E value of 2.0 or more.

9. The polyimide according to claim 6, wherein the structural unit of the polyimide comprises a structural unit derived from the diamine monomer having an E value of 2.0 or more, and the structural unit derived from the dianhydride monomer having an E value of 2.5 to 5.0.

10. The polyimide according to claim 1, wherein a content of the structural unit derived from the polyimide precursor monomer is 10 mol % or more.

11. A polyimide film prepared from the polyimide according to claim 1.

12. The polyimide film according to claim 11, wherein a yellowness index measured according to a standard of ASTM E313 is 3.5 or less.

13. A method for selecting a polyimide precursor monomer, comprising:
calculating E values of each of polyimide raw materials according to Equation 1; and
selecting a compound having an E value of 2.0 or more among the polyimide raw materials:
$$E = \frac{1 - 2.2 x}{y} \times \frac{1000}{Mw} \qquad [ Equation 1 ]$$
wherein, in Equation 1, x is an x value of each of polyimide raw materials on a CIE xy chromaticity diagram, y is a y value of the each of polyimide raw materials on the CIE xy chromaticity diagram, and Mw is a molecular weight of the each of the polyimide raw materials.

14. The method according to claim 13, further comprising calculating the x value and the y value of each of the polyimide raw materials by Equations 2 and 3, respectively, before calculating the E values of each of the polyimide raw materials:
x=X_{Z}/(X_{Z}+Y_{Z}+1) [Equation 2]
y=Y_{Z}/(X_{Z}+Y_{Z}+1) [Equation 3]
wherein, in Equations 2 and 3, X_{Z} and Y_{Z} are values calculated by Equations 4 and 5, respectively:
$${X}_{Z} = {\sum }_{λ = 380}^{780} X ( λ ) \cdot C ( λ ) \cdot {10}^{- A b s ( λ )} / {\sum }_{λ = 380}^{780} Z ( λ ) \cdot C ( λ ) \cdot {10}^{- A b s ( λ )} \qquad [ Equation 4 ]$$
$${Y}_{{Z}^{=}} {\sum }_{λ = 380}^{780} Y ( λ ) \cdot C ( λ ) \cdot {10}^{- A b s ( λ )} / {\sum }_{λ = 380}^{780} Z ( λ ) \cdot C ( λ ) \cdot {10}^{- A b s ( λ )} \qquad [ Equation 5 ]$$
wherein, in Equations 4 and 5, X(λ), Y(λ), and ZOO are values from color matching functions of a CIE standard observer at a corresponding wavelength λ on an CIE XYZ color space, C(λ) is a CIE standard light source C at the corresponding wavelength λ, and Abs(λ) is an absorbance of the polyimide raw material at the corresponding wavelength λ.

15. The method according to claim 14, wherein the absorbance of each of the polyimide raw materials is obtained from a UV/Vis spectrum of the polyimide raw material.

16. The method according to claim 15, before calculating the x value and y value of each of the polyimide raw materials, further comprising:
calculating the UV/Vis spectrum of each of the polyimide raw materials by a time-dependent density functional theory (TD-DFT); and
calculating the absorbance of each of the polyimide raw materials from the UV/Vis spectrum.

17. The method according to claim 16, further comprising optimizing a molecular structure of each of the polyimide raw materials by a density functional theory (DFT) before calculating the UV/Vis spectrum of each of the polyimide raw materials.

18. The method to claim 13, wherein the polyimide raw materials comprise a diamine monomer or a dianhydride monomer.

19. A method of preparing a polyimide comprising reacting a diamine monomer and a dianhydride monomer,
wherein at least one of the diamine monomer and the dianhydride monomer comprises a polyimide precursor monomer selected by the method according to claim 13.

20. The method according to claim 19, wherein an E value of the diamine monomer and an E value of the dianhydride monomer are 2.0 or more.
